(19) United States
(12) Patent Application Publication
(10) Pub. No.: US 2023/0036407 A1
(43) Pub. Date: Feb. 2, 2023

(54) SYSTEMS AND METHODS FOR ADAPTIVE BASELINE CONTAINER IMAGE BASED ON PREBOOT CONTEXT

(71) Applicant: Dell Products L.P., Round Rock, TX (US)

(72) Inventors: Vivek Viswanathan IYER, Austin, TX (US); Balasingh P. SAMUEL, Round Rock, TX (US)

(73) Assignee: Dell Products L.P., Round Rock, TX (US)

(21) Appl. No.: 17/391,471

(22) Filed: Aug. 2, 2021

(51) Int. Cl. G06F 21/57; H04L 9/32

(52) U.S. Cl. CPC G06F 21/572; H04L 9/3247; G06F 2221/033

(57) ABSTRACT

An information handling system may include a processor and a basic input/output system communicatively coupled to the processor and embodied by executable instructions embodied in non-transitory computer readable media, the instructions configured to, when executed by the processor, in a pre-operating system environment of the information handling system: determine contextual information associated with the information handling system and based on the contextual information, select a baseline container image to be executed by an operating system of the information handling system.

### TECHNICAL FIELD

The present disclosure relates in general to information handling systems, and more specifically to securing operating system applications in an information handling system with a hardware root of trust.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Using traditional approaches, a user's “experience” in using an information handling system remains the same regardless of the user's context (e.g., location, time of day, day of week, etc.). For example, in traditional approaches, a user may have access to the same features whether on a secure network maintained by an administrator of the information handling system or a public network at a coffee shop. However, in such example, it may be desirable that, for security purposes, the user has access to fewer features on the public network.

### SUMMARY

In accordance with the teachings of the present disclosure, the disadvantages and problems associated with traditional approaches may be reduced or eliminated.

In accordance with embodiments of the present disclosure, an information handling system may include a processor and a basic input/output system communicatively coupled to the processor and embodied by executable instructions embodied in non-transitory computer readable media, the instructions configured to, when executed by the processor, in a pre-operating system environment of the information handling system: determine contextual information associated with the information handling system and, based on the contextual information, select a baseline container image to be executed by an operating system of the information handling system.

In accordance with these and other embodiments of the present disclosure, a method comprising, in a basic input/output system of an information handling system during a pre-operating system environment of the information handling system: determining contextual information associated with the information handling system and, based on the contextual information, selecting a baseline container image to be executed by an operating system of the information handling system.

In accordance with these and other embodiments of the present disclosure, an article of manufacture may include a computer readable medium and computer-executable instructions carried on the computer readable medium, the instructions readable by a processor, the instructions, when read and executed, for causing the processor to, in a basic input/output system of an information handling system during a pre-operating system environment of the information handling system: determine contextual information associated with the information handling system and, based on the contextual information, select a baseline container image to be executed by an operating system of the information handling system.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with certain embodiments of the present disclosure; and

FIG. 2 illustrates a flow chart of an example method for selection of an adaptive baseline container image based on preboot context, in accordance with certain embodiments of the present disclosure.

### DETAILED DESCRIPTION

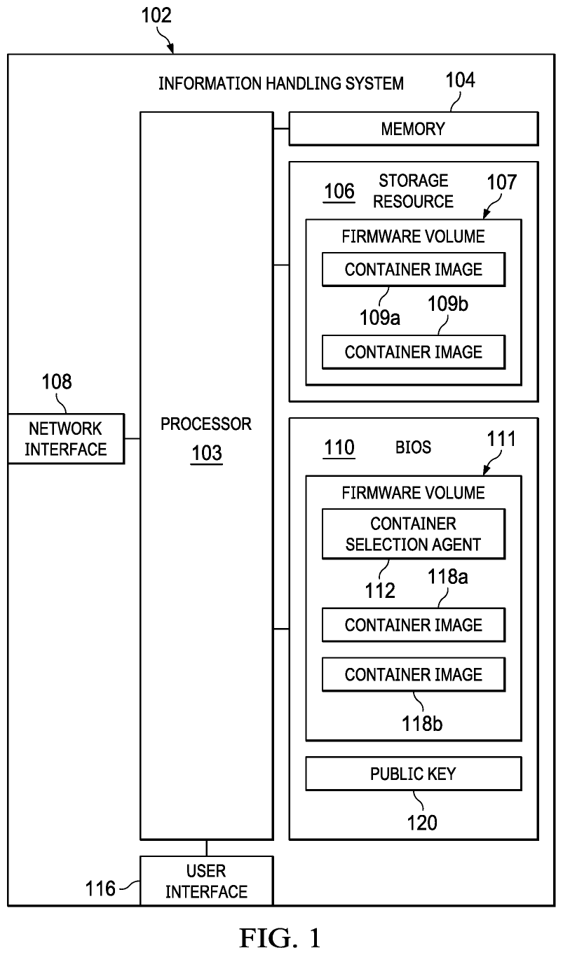

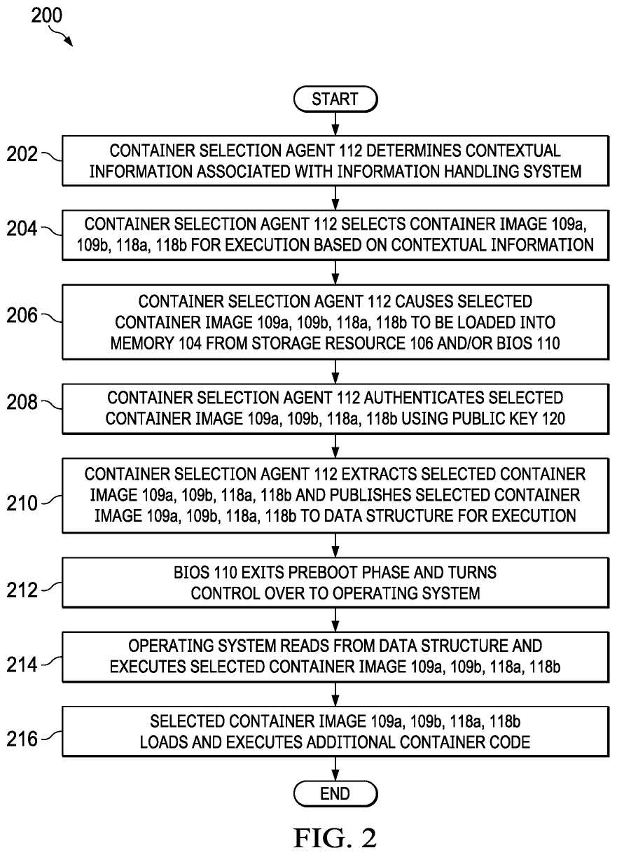

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

FIG. 1 illustrates a block diagram of an example information handling system 102, in accordance with certain embodiments of the present disclosure. In some embodiments, information handling system 102 may be a server. In other embodiments, information handling system 102 may be a personal computer (e.g., a desktop computer or a portable computer). As depicted in FIG. 1, information handling system 102 may include a processor 103, a memory 104 communicatively coupled to processor 103, a storage resource 106 communicatively coupled to processor 103, a network interface 108 communicatively coupled to processor 103, a basic input/output system (BIOS) 110 communicatively coupled to processor 103, and a user interface 116 coupled to processor 103.

Processor 103 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, storage resource 106, BIOS 110, and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

Storage resource 106 may be communicatively coupled to processor 103 and may include any system, device, or apparatus configured to retain program instructions or data for a period of time (e.g., a computer-readable medium). In some embodiments, storage resource 106 may include a hard disk drive, a magnetic tape library, an optical disk drive, a magneto-optical disk drive, a compact disc drive, a solid state storage drive, a flash drive and/or any other suitable computer-readable medium. In some embodiments, storage resource 106 may reside internal to a chassis or other enclosure comprising information handling system 102 and not be readily accessible without opening such chassis or other enclosure. In other embodiments, storage resource 106 may reside internal to a chassis or other enclosure comprising information handling system 102.

As shown in FIG. 1, storage resource 106 may include a firmware volume 107. As is known in the art, a firmware volume may comprise a file-level interface to firmware storage. Firmware volume 107 may support some other type of storage entirely, such as a disk partition or network device. For example, as described in greater detail herein, firmware volume 107 may support the storage of container images 109 stored on storage resource 106.

As also shown in FIG. 1, firmware volume 107 may include a plurality of container images 109 (e.g., container images 109a, 109b) stored therein. Each container image 109 may include a program of instructions for executing a container. A container is a form of operating system virtualization. A single container might be used to run anything from a small microservice or software process to a larger application. Thus, a container may include necessary executables, binary code, libraries, and/or configuration files for performing the functionality and features of the container. A container may include a software container that virtualizes a software service, process, or application, or a container that virtualizes hardware.

Network interface 108 may comprise any suitable system, apparatus, or device operable to serve as an interface between information handling system 102 and a network comprising one or more other information handling systems. Network interface 108 may enable information handling system 102 to communicate over such a network using any suitable transmission protocol and/or standard, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network interface 108 may interface with one or more networks implemented as, or as part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). In certain embodiments, network interface 108 may comprise a network interface card, or “NIC.”

BIOS 110 may be communicatively coupled to processor 103 and may include any system, device, or apparatus configured to identify, test, and/or initialize information handling resources of information handling system 102. “BIOS” may broadly refer to any system, device, or apparatus configured to perform such functionality, including without limitation, a Unified Extensible Firmware Interface (UEFI). In some embodiments, BIOS 110 may be implemented as a program of instructions that may be read by and executed on processor 103 to carry out the functionality of BIOS 110. In these and other embodiments, BIOS 110 may comprise boot firmware configured to be the first code executed by processor 103 when information handling system 102 is booted and/or powered on. As part of its initialization functionality, BIOS code may be configured to set components of information handling system 102 into a known state, so that one or more applications (e.g., an operating system or other application programs) stored on compatible media (e.g., memory 104) may be executed by processor 103 and given control of information handling system 102.

As shown in FIG. 1, BIOS 110 may include a firmware volume 111. Firmware volume 111 may be similar in many respects to firmware volume 107 except that firmware volume 111 may be embodied in BIOS 110 (e.g., serial peripheral interface read-only memory associated with BIOS 110).

As further shown in FIG. 1, firmware volume 111 may comprise container selection agent 112 stored therein. Container selection agent 112 may comprise a program of instructions executed during a preboot phase (e.g., before execution of an operating system or hypervisor of information handling system 102) that may be configured to, as described in greater detail below, select a container image 109a, 109b, 118a, or 118b for execution based on preboot contextual data associated with information handling system 102, authenticate such container image 109a, 109b, 118a, or 118b and cause execution of such container image.

As also shown in FIG. 1, firmware volume 111 may also include a plurality of container images 118 (e.g., container images 118a, 118b) stored therein. Each container image 118 may include a program of instructions for executing a container.

BIOS 110 may also have stored thereon a public key 120. As described in greater detail below, public key 120 may comprise any suitable cryptographic key associated with a private key of a private-public key pair in which the private key may be used to sign container images 109, 118 and public key 120 may be used to verify signatures of container images 109, 118.

User interface 116 may comprise any instrumentality or aggregation of instrumentalities by which a user may interact with information handling system 102. For example, user interface 116 may permit a user to input data and/or instructions into information handling system 102 (e.g., via a keyboard, pointing device, and/or other suitable component), and/or otherwise manipulate information handling system 102 and its associated components. User interface 116 may also permit information handling system 102 to communicate data to a user, e.g., by way of a display device.

In operation, as part of provisioning of information handling system 102 (e.g., factory provisioning and/or updates of information handling system 102), multiple container images 109, 118 may be securely installed within firmware volumes 107, 111 of information handling system 102. Prior to installation, a hardware security module (HSM) server may certify such container images 109, 118 using a code signing policy (e.g., Microsoft code signing policy), and may also be signed using a private key of a manufacturer, vendor, or other provider of information handling system 102 such that only container images authorized by the provider are allowed to be executed on information handling system 102. Such private key may be maintained by the provider on the HSM server, which may be remotely coupled to information handling system 102 via network interface 108. The HSM server may also provision public key 120 corresponding to the private key on BIOS 110.

By default, container images 109, 118 may be installed in a factory, and in some embodiments, container update processes may be employed to update or promote new container images 109, 118. Such container update process may be either a standalone firmware utility or firmware capsule update (e.g., using Windows Update process).

Further, as described in greater detail below, container selection agent 112 may, during the preboot phase of information handling system 102, determine a context associated with information handling system 102 and select a container image 109a, 109b, 118a, or 118b for execution.

FIG. 2 illustrates a flow chart of an example method 200 for selection of an adaptive baseline container image based on preboot context, in accordance with certain embodiments of the present disclosure. According to some embodiments, method 200 may begin at step 202. As noted above, teachings of the present disclosure may be implemented in a variety of configurations of information handling system 102. As such, the preferred initialization point for method 200 and the order of the steps comprising method 200 may depend on the implementation chosen.

At step 202, in response to powering on or resetting of information handling system 102, container selection agent 112 may determine contextual information associated with information handling system 102. Such contextual information may include any suitable information regarding use of information handling system 102, including without limitation a geographic location of information handling system 102, a network address (e.g., Internet Protocol address) of information handling system 102, a user selection from a preboot boot selection menu, a user-entered hot key sequence, identity of a user of information handling system 102, and/or other factors.

At step 204, based on the contextual information, container selection agent 112 may select a container image 109a, 109b, 118a, or 118b for execution. In some embodiments, container selection agent 112 may employ one or more rules for selection of a container image 109a, 109b, 118a, or 118b for execution.

At step 206, container selection agent 112 may cause the selected container image 109a, 109b, 118a, or 118b to be loaded into memory 104 from storage resource 106 and/or BIOS 110. At step 208, container selection agent 112 may authenticate the selected container image 109a, 109b, 118a, or 118b using public key 120.

At step 210, if the selected container image 109a, 109b, 118a, or 118b is successfully authenticated, container selection agent 112 may extract the selected container image 109a, 109b, 118a, or 118b and publish selected container image 109a, 109b, 118a, or 118b to a data structure for execution. For example, in some embodiments, container selection agent 112 may publish the selected container image 109a, 109b, 118a, or 118b into a Windows Platform Binary Table (WPBT), and in turn cause the WPBT to be added to an Advanced Configuration and Power Interface (ACPI) table for consumption by an operating system.

At step 212, BIOS 110 may exit the preboot phase and turn control over to an operating system executing on information handling system 102. At step 214, operating system initialization code may read from the data structure (e.g., the ACPI table) and execute the selected container image 109a, 109b, 118a, or 118b published to the data structure.

Thus, a base-level container image may automatically be loaded and executed based on context of information handling system 102. At step 216, during execution of the selected container image 109a, 109b, 118a, or 118b the selected container image 109a, 109b, 118a, or 118b may load and execute additional container code as defined by the selected container image 109a, 109b, 118a, or 118b, such additional container code stored on storage media local to information handling system 102 (e.g., storage resource 106) and/or stored remotely (e.g., on a cloud) on storage media communicatively coupled to network interface 108.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented using information handling system 102 or any other system operable to implement method 200. In certain embodiments, method 200 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a processor; and
a basic input/output system communicatively coupled to the processor and embodied by executable instructions embodied in non-transitory computer readable media, the instructions configured to, when executed by the processor, in a pre-operating system environment of the information handling system:
determine contextual information associated with the information handling system; and
based on the contextual information, select a baseline container image to be executed by an operating system of the information handling system.

2. The information handling system of claim 1, the basic input/output system further configured to, in the pre-operating system environment of the information handling system, authenticate the baseline container image.

3. The information handling system of claim 2, the basic input/output system further configured to, in the pre-operating system environment of the information handling system, authenticate the baseline container image using a public key corresponding to a private key used to sign the baseline container image.

4. The information handling system of claim 1, the basic input/output system further configured to, in the pre-operating system environment of the information handling system, publish the baseline container image to a data structure used by the operating system to determine which code to execute.

5. The information handling system of claim 1, wherein the contextual information includes one or more of: a geographic location of the information handling system, a network address of the information handling system, user-input, and an identity of a user of the information handling system.

6. A method comprising, in a basic input/output system of an information handling system during a pre-operating system environment of the information handling system:
determining contextual information associated with the information handling system; and
based on the contextual information, selecting a baseline container image to be executed by an operating system of the information handling system.

7. The method of claim 6, further comprising, in the pre-operating system environment of the information handling system, authenticating the baseline container image.

8. The method of claim 7, further comprising, in the pre-operating system environment of the information handling system, authenticating the baseline container image using a public key corresponding to a private key used to sign the baseline container image.

9. The method of claim 6, further comprising, in the pre-operating system environment of the information handling system, publishing the baseline container image to a data structure used by the operating system to determine which code to execute.

10. The method of claim 6, wherein the contextual information includes one or more of: a geographic location of the information handling system, a network address of the information handling system, user-input, and an identity of a user of the information handling system.

11. An article of manufacture comprising:
a computer readable medium; and
computer-executable instructions carried on the computer readable medium, the instructions readable by a processor, the instructions, when read and executed, for causing the processor to, in a basic input/output system of an information handling system during a pre-operating system environment of the information handling system:
determine contextual information associated with the information handling system; and
based on the contextual information, select a baseline container image to be executed by an operating system of the information handling system.

12. The article of claim 11, further comprising, in the pre-operating system environment of the information handling system, authenticating the baseline container image.

13. The article of claim 12, further comprising, in the pre-operating system environment of the information handling system, authenticating the baseline container image using a public key corresponding to a private key used to sign the baseline container image.

14. The article of claim 11, further comprising, in the pre-operating system environment of the information handling system, publishing the baseline container image to a data structure used by the operating system to determine which code to execute.

15. The article of claim 11, wherein the contextual information includes one or more of: a geographic location of the information handling system, a network address of the information handling system, user-input, and an identity of a user of the information handling system.
